(19) United States
(12) Patent Application Publication
(10) Pub. No.: US 2009/0163641 A1
(43) Pub. Date: Jun. 25, 2009

(54) NATURAL ALUMINOSILICATE COMPOSITES AND AGGREGATES SYNTHESIZED IN ALKALINE ENVIRONMENT AND THEIR MANUFACTURING PROCESS

(76) Inventors: Rodolfo Dafico Bernardes de Oliveira, Goiânia/go (BR); Humberto Dafico Bernardes de Oliveira, Goiânia (BR)

Correspondence Address: FURR LAW FIRM, 2622 DEBOLT ROAD, UTICA, OH, 43080, US

(21) Appl. No.: 11/915,387

(22) PCT Filed: May 12, 2006
(86) PCT No.: PCT/BR06/00097

§ 371 Date: Nov. 25, 2007

(51) Int. Cl. C08K 3/36

(52) U.S. Cl. 524/447

(57) ABSTRACT

The present invention is a direct reactive process of inorganic polymerization used to obtain composites whose polymeric matrix does not require chemical or thermal pre-activation of the mixture reactors of specific natural aluminosilicates and varied aggregates, in the manufacture of alternatives to ceramics, Portland cement, timber, gypsum and metallic frames, through an adequate mixture added to the inorganic matrix of one or more natural aggregates (silica, limestone, hydrated lime, vermiculite, asbestos fibers) combined or not with synthetic alkaline-resistant aggregates (tire rubber, polypropylene fibers, nylon, PVA). To these, an alkaline solution of water and sodium hydroxide and/or potassium hydroxide will be added for the molding or extrusion and cutting out of artifacts, which will be oven-dried and polymerized at temperatures between 100° C. and 500° C.

The present invention relates to aluminosilicate composites which are obtained through a manufacturing process that allows the production of artifacts that can be molded or extruded and, in whose manufacture, certain raw materials may be aggregated and thus obtain, according to each aggregate, products that could replace traditional ceramics, Portland-cement pre-cast products, timber, plastics, agglomerated plates, aluminum and fiber cement.

During he process of manufacture the product is obtained through the compression or extrusion of aluminosilicate and aggregates in highly alkaline (sodium or potassium) aqueous environment and heat addition, so as to obtain a reaction at temperatures well below the fusion point of the clay-mineral paste. This process will result in products used in the manufacture of: roofing tiles, ceramic and fiber cement panels, molds, frames, floor tiles, coatings, blocks, pre-cast slabs and bricks and concrete or ceramic pipes, in addition to gypsum or timber ceilings, partitions and similar products.

The growing need to preserve the environment and the concern of most countries in this respect has led to the development of countless technological processes that aim to achieve sustainable development with lower levels of environmental degradation. In their turn, the cement and ceramics industries, notwithstanding their efforts to innovate and improve their procedures, still rely on techniques and processes that fall short of meeting the expectations of this new society in terms of reducing the environmental impact brought about by the large quantity of energy pollution during production and the inherent high levels of CO2 emissions.

Since the dawn of time mankind has been familiar with techniques for the production of clay products, whose principle is based on synterization, through the fusion of the components with the clay-mineral mixture. If, on the one hand, there is abundant raw material, on the other, the burning process is costly as implies the strict control of humidity to avoid shrinkage,

warping and cracks in the products or even their burning, caused by the high temperatures, which normally range between 800 and 1400 degrees Celsius in the manufacture of clay products.

In the case of Portland cement, despite its widespread use, the principle is based on complex chemical reactions resulting from the calcium bonds—still under study—which are characterized by mixtures with high humidity content and longer curing periods.

Alternatives to Portland cement were the object of preliminary studies by Glukhovsky in the Ukraine, in the mid 1950s, with reasonable practical application in cement processes with the use of aluminosilicate combined with calcium silicate in alkaline environment. These studies were later taken up and consolidated by French researcher Joseph Davidovits who, alongside his associates, produced countless publications and patents (USA patents Nrs. 5342595/53491 18/5352427/5539140/5925449) relating to a new material with broad potential use and applications. This material is synthesized under certain conditions and proportions, and was called “geopolymer,” a versatile inorganic adhesive based on the polymerization reactions of active aluminosilicates and silica in highly alkaline environment and at near ambient temperatures. As a particular classical example of the polymer reaction, metakaolinite, {2{AL2O2SI2O5}n+4 H2O}, was used after being obtained from the thermal activation of kaolinite {2[AL2SI2O5(OH)4}} at furnace temperatures of 7000 C for about 2 hours, as a means to carry out the conversion of aluminum with octahedral (kaolinite) into tetrahedral coordination (metakaolinte), thus making it reactive. Important contributions were made to the understanding of the polymeric process by Comrie, Balaguru, Gauckler, Zhang and others, with countless proposed patents, which share the same principle while particularizing the techniques and processes, such as the use of silica fume, silicates, metasilicates, oxides etc. In technical' terms, the known artifacts are restricted to the use of traditional ceramic, Portland cement and geopolymer.

In the case of ceramics, the major drawbacks are the high economic and environmental costs required to produce them, given their need to reach high temperatures and that they cannot be manufactured in larger sizes due to high shrinkage. With regard to Portland-cement based products, in addition to the high economic and environmental cost in their production—similarly to ceramic products—there is also the inconvenient impossibility of extrusion, the high shrinkage rates and the need for long cures. The latter stems from the fact that products based on Portland cement have low early strength and unsatisfactory thermal insulation rates from the viewpoint of current technical standards.

Finally, regarding the production of artifacts known as geopolymers, of public domain too, it is worth noting that their production is limited by the need and consequent high cost of adjusting the raw material, since the natural occurrences of aluminosilicate are characterized by a wide range of particle sizes, micro-element composition, Si:AI ratio, specific surface and chemical reactivity, thus rendering their natural use impractical and conditioning the success of the polymeric reaction to the physical-chemical alterations induced on the reactors, such as: thermal activation, high-purity silicates, use of silica fume, increase in specific surface, oxides and others. The development of the present manufacturing process aimed not only to overcome such drawbacks and obtain products that do not have the same limitations of existing products, but also to meet current specification standards and market needs.

The manufacturing process that was developed is a direct reaction one which does not require any sort of chemical or thermal pre-activation of the components of the inorganic polymerization reaction, and will be employed to obtain natural aluminosilicate composites with synthesized aggregates in alkaline environment. The production of the resulting artifacts begins with the digging of deposits to extract the clay (aluminosilicate) that will be used to manufacture the artifacts, followed by the declodding and sieving of the clay so as to achieve a homogenous grading (sieve #50 produces best results).

Immediately afterwards the choice of the aggregate to be used in the composite is made, and

could include both natural aggregates—such as silica, limestone powder, vermiculite—and synthetic rubber aggregates and synthetic fibers that can resist alkalinity, among others.

Natural aggregates that absorb water very well can be mixed directly with the clay, until a homogeneous mixture of all these raw materials is reached with the addition of an alkaline catalyst in aqueous solution composed by H2O+NAHO and/or KOH. This leads to a new mixture so as to obtain a new homogenization that undergoes extrusion and/or casting of the artifacts, so that the pieces (artifacts) will be obtained through cutting when the composite is extruded, or through casting when the composite is obtained by molding. These pieces are then taken, at first, to a drying oven at a temperature between 800 C and 1000 C and later undergo polymerization as we will see further ahead.

As for synthetic aggregates, such as rubbers, polypropylene fibers, nylon and others that resist an alkaline environment, they can be previously mixed with the alkaline catalyst in an aqueous solution of H2O+NAHO and/or KOH to reach an improved homogenization, since they feature a higher hydrophobicity, unlike natural aggregates, and thus require a longer contact period for the improved homogenization of the said synthetic aggregates which will subsequently be mixed with the clay (aluminosilicate) to obtain the composite paste that will allow the extrusion and/or casting of the artifacts.

The polymerization of the artifacts obtained from the composites will take place—in certain cases and depending also on the type of aggregate used—in the oven itself by the simple increase in drying temperature to a temperature of around 1800 C. However, for certain types of artifacts obtained from certain aggregates (which will be exemplified further ahead), there will be a need to conduct the said polymerization in a furnace, so that after drying in the oven, the artifacts will be taken to the furnace at a temperature of up to 5000 C. After polymerization, be it in the oven or in the furnace, the artifacts will be removed for natural cooling, so that they may reach ambient temperatures gradually and bring to an end the polymerization process, before proceeding to curing and storage and being ready to be marketed.

The polymerization of the artifacts, the object of the present claim, will likewise be conducted after the complete homogenization of the paste resulting from the mixture described above and the casting or extrusion. The cutting or molding for subsequent heat addition will follow. The heat intensity and exposure period should be specific to the matrix aggregates, and may vary between 800 C and 5000 C. If drying temperatures below this range are used, the complete polymerization of the composite will not be achieved, while temperatures above that range will lead to a decrease in the desirable mechanical characteristics for the manufactured artifacts, in addition to higher production costs. In this way, and with the use of natural aluminosilicates and aggregates without pre-activation to achieve the reaction, it was possible to create a non-stop process of artifact manufacture, that is, a continuous process in the stages of casting or extrusion and paste curing, through the compression/molding and immediate heat addition as a means to catalyze the reaction that already occurs in the mixture, given the addition of the catalyst (aqueous solution to the aluminosilicate and its aggregates). This does away with the need for specific conditions of pre-treatment/activation of the basic reactors, which are normally achieved in laboratory procedures, making the process impractical from the viewpoint of the production costs. In this process there is also the possibility of including a post-curing technique comprising the water immersion of the product burnt at between 2000 C and 5000 C after cooling at room temperature. This is a means to potentialize the desirable mechanical characteristics of the polymeric process. The finished products that are manufactured by the above processes differ substantially from the ceramic and Portland cement products as they achieve better aesthetic and mechanical features in a shorter amount of time, by making use of a reaction to temperatures between 800 C and 5000 C, varying according to the aggregate that is mixed with the clay The present invention was achieved by mixing certain natural aluminosilicates, with a predominant kaolinite mineralogical characterization (through quantitative analysis by X-ray fluorescence spectrometry) of AI2O3

“ • *−• V V U / /

contents between 25% and 40% and SiO2 between 40% and 60%, loss to ignition between 8% and 15%, as well as a minimum content of amorphous material of 0.5% and featuring low crystallinity. These aluminosilicates were used as the polymeric matrix of the composite when added to various aggregates, in combination or not, and which afforded the final product the lowest shrinkage and warping rates while drying, the lowest value in water absorption and an increase in abrasion and compressive strength. These aggregates are, typically, sand, limestone and lime. According to the required specific mechanical and aesthetic characterizations, one may also add natural or synthetic particles and/or fibers, vermiculite, rubbers and color agents. To this dry mixture is added an alkaline solution comprising water and NAOH and/or KOH (in varying proportions according to the aggregates and final use). The NaOH or the KOH can occasionally be replaced with other alkalizing agents containing sodium or potassium, such as sodium silicate, sodium metasilicate or sodium carbonate, etc. Finally, once the polymerization is effected, it is possible to qualify the composite obtained according to its application, which can cover countless specific uses or may be an advantageous substitute to traditional composites, due not only to the intrinsic quality of the materials but also to its versatility as far as their industrialization is concerned. The environmental aspect is also worthy of note, since this product can make use of raw materials such as aggregates—employed in the clay mixture—which are normally discharged into the environment. Examples include rubber tires, plastics and polypropylenes.

Therefore, it can be concluded that from different materials and aggregate proportions in the matrix, it is possible to obtain composites with entirely diverse characterizations and employments, which will be specified below. These will range from those of simpler formulation to the more complex ones. Their mix compositions, temperatures, aggregate proportions, catalyst mixtures (aqueous solution), mixing, homogenization and molding processes will be described below. The possibilities for clay (aluminosilicate) mixtures and aggregate use in the manufacture of artifacts using the processes below are by no means exhausted in these examples, nor are the

formulations/proportions exemplified below limiting factors in the characterization of the invention, where:

### EXAMPLE 1

### Ceramic Composite with Physical Characterization Resembling Traditional Red Ceramics

Polymeric matrix: Aluminosilicate (dry and finely crushed, passing through a #50 sieve).

Aggregates: Washed sand and limestone powder (both dry and finely crushed).

Matrix/aggregate ratio in weight: 1:1 with 15% deviation Ratio between aggregates in weight: 1:1 with 50% deviation

Catalyst: preferably, scaled sodium or potassium hydroxide (commercial use).

Catalyst/dry mixture ratio in weight: between 1.5% and 12%, depending on the crystallinity increase intended for the composite. The application of the catalyst must be made by completely diluting it in the reaction water. Water/dry mixture ratio in weight: between 10% and 20%—preferably 14% (it was noted that values below this range cannot completely humidify the mixture and consequently the reaction is incomplete, while for water quantities above this range, the indices of composite crystallinity tend to drop).

Mixing and homogenization: to the dry mixture the catalyst, previously diluted in water (already mixed with the coloring agents, if this is the case), is added, slowly and in an adequate device for homogenization (stirrers with low rotation blades, for example), thus proceeding until the resulting paste is completely hydrated and without lumps, while also featuring a certain plasticity.

Molding/casting: The paste resulting from the homogenization process can be used in extrusion mechanisms or proceed to casting by compression.

Drying: This is done, preferably, in an oven at 80 degrees Celsius for a minimum period of two hours. This time can be increased to up to six hours for pieces of higher density.

Polymerization: This stage comprises the processes of temperature elevation after oven drying in a furnace at up to 500 degrees Celsius, remaining at this level for a period of around one hour.

Cure: The removal of the composite from the furnace will be conducted so that cooling is gradual. The composite will feature excellent mechanical characteristics which will be potentialized in up to 50% through curing by immersion in water for five days, a process which will be extended in dry mode for up to 20 days. Water absorption of the final product: From 10% to 12%, comparable to traditional (synterized) ceramic products. In some aggregate mix proportions and compositions, efflorescence was observed, possibly as a result of an incomplete reaction.

Thermal/acoustic insulation: Excellent, comparable to that of traditional ceramics.

Specific weight: Around 2,000 kg per cubic meter.

Uses: roofing tiles, bricks, blocks, renderings and concrete precasts.

### EXAMPLE 2

### Ceramic Composite with Lime

featuring a physical characterization similar to the traditional semigres ceramics. Polymeric matrix: Dry, finely crushed aluminosilicate, passing through sieve #50.

Aggregates: Washed sand, limestone powder, hydrated lime, all of which dry.

Matrix/aggregate ratio in weight: 1:1 with a 15% deviation.

Ratio between aggregates, in weight: 2:1 (sand and/or limestone powder)/hydrated lime with a 35% deviation. Catalyst: preferably, sodium or potassium hydroxides in scales (commercial use).

Catalyst/dry mixture ratio, in weight: between 1.5% and 12%, depending on the crystallinity increase intended for the composite. The application of the catalyst must be made after it has been completely diluted in the reaction water.

Water/dry mixture ratio, in weight: between 10% and 20%—preferably 14% (it was noted that values below this range cannot completely humidify the mixture and consequently the reaction is incomplete, while for water quantities above this range, the indices of composite crystallinity tend to drop).

Mixing and homogenization: to the dry mixture the catalyst, previously diluted in water (already mixed with the coloring agents, if this is the case), is added, slowly and in an adequate device for homogenization (stirrers with low rotation blades, for example), thus proceeding until the resulting paste is completely hydrated and without lumps, while also featuring a certain plasticity.

Molding/casting: The paste resulting from the homogenization process can be used in extrusion mechanisms or proceed to casting by compression.

Drying: This is done, preferably, in an oven at 80 degrees Celsius for a minimum period of two hours. This time can be increased to up to six, hours for pieces of higher density.

Polymerization: This stage comprises the processes of temperature elevation after oven drying in a furnace at up to 500 degrees Celsius, remaining at this level for a period of around one hour. Cure: The removal of the composite from the furnace will be conducted so that cooling is gradual. The composite will feature excellent mechanical characteristics which will be potentialized in up to 50% through dry curing for up to 20 days.

Water absorption of the final product: From 5% to 8%, comparable to traditional (synterized) ceramic products. Thermal/acoustic insulation: Excellent, comparable to that of traditional ceramics.

Specific weight: Around 2,000 kg per cubic meter.

Uses: Physical/mechanical characterization of composite according to use in:
Tiles—flexural rupture load, impermeability, water absorption, shrinkage, warping and tortion: compliant with the Brazilian technical standards NBR 13582, NBR 8947, NBR 8948, NBR 6462 and NBR 9602.
Bricks: Shrinkage, square deviation and flatness of sides, water absorption and compressive strength: compliant with NBR 7171, NBR 8947 and NBR6461. Substitution of concrete precasts.
Coating plates: size deviation rates, water absorption, impact resistance, abrasion strength, cracking, and thermal dilatation: compliant with NBR 13816, NBR 13817 and NBR 13818.

Appearance of the finished product: according to the use and need to provide a better finishing of the cast/extruded object's surface, the following may be applied to the latter: polyester epoxy-based, or hybrid polyester-epoxy based, powdered paints, as well as PVA-based resins, acrylic or polyurethane resins and even recycled PET film.

### EXAMPLE 3

### Ceramic Composite with Lime and Fibers

This composite, while retaining the desirable characteristics of semigres ceramic, incorporates some qualities inherent to timbers and their by-products, including tensile strength and the facility with which the composite body is easily sawn, pierced with nails, screwed into etc.

Polymeric matrix: Aluminosilicate (dry and finely crushed, passing through a #50 sieve).

Aggregates: Washed sand, limestone powder and hydrated lime (all of which dry), alkaline-resistant fibers (polypropylene, PVA, Nylon, etc). Matrix/aggregate ratio in weight: 1:1 with 15% deviation

Ratio between aggregates in weight: 2:1 (sand and/or limestone powder)/hydrated lime with 35% deviation, added with polypropylene fibers up to 8% of the total weight of the dry mixture.

Catalyst: preferably, scaled sodium or potassium hydroxide (commercial use).

Catalyst/dry mixture ratio in weight: between 3% and 12%, depending on the crystallinity increase intended for the composite. The application of the catalyst must be made by completely diluting it in the reaction water.

Water/dry mixture ratio in weight: between 20% and 30%—preferably 25% (it was noted that values below this range cannot completely humidify the mixture and consequently the reaction is incomplete, while for water quantities above this range, the indices of composite crystallinity tend to drop).

Mixing and homogenization: to the dry mixture the catalyst, previously diluted in water (already mixed with the coloring agents, if this is the case), is added, slowly and in an adequate device for homogenization (stirrers with low rotation blades, for example), thus proceeding until the resulting paste is completely hydrated and without lumps, while also featuring a certain plasticity.

Molding/casting: The paste resulting from the homogenization process can be used in extrusion mechanisms or proceed to casting by compression. It can also be submitted to molding mechanisms. Drying: This is done, preferably, in an oven at 80 degrees Celsius for a minimum period of two hours. This time can be increased to up to six hours for pieces of higher density.

Polymerization: This stage comprises the processes of temperature elevation after oven drying, from 80 degrees Celsius to 100 degrees Celsius, remaining at this level for a period of around two hours.

Cure: The removal of the composite from the furnace will be conducted so that cooling is gradual. The composite will feature excellent mechanical characteristics which will be potentialized in up to 50% through dry curing for up to 20 days.

Water absorption of the final product: From 5% to 8%, comparable to traditional (synterized) semigres ceramic products.

Thermal/acoustic insulation: Excellent, comparable to that of traditional ceramics. Specific weight: Around 1,700 kg per cubic meter.

Uses: Due to the inherent characteristics of the ceramic composite with lime and fibers, it displays great versatility in replacement of timber and by-products, fiber cements, concrete precasts, plastics, gypsum, gypsum wallboards and in some cases even metallic plates and frames. Surface reinforcement: Optionally, in some specific cases, and aiming to substantially increase the finished product's flexural and/or torsion strength, a mesh of synthetic or natural fibers like polypropylene, cotton, paper, card, polyester, sisal, nylon etc can be glued on the body of the composite in differing quantities and layouts. Appearance of the finished product: according to the use and need to provide a better finishing of the cast/extruded object's surface, the following may be applied to the latter: polyester epoxy-based, or hybrid polyester-epoxy based, powdered paints, as well as PVA-based resins, acrylic or polyurethane resins and even recycled PET film.

### EXAMPLE 4

### Rubber Composite

Despite high susceptibility to water, this composite has low specific weight, and can replace gypsum in pre-cast pieces.

Polymeric matrix: Dry, finely crushed aluminosilicate, passing through sieve #50.

Aggregates: rubber from used car tires (finely crushed and passing through sieves #20 to #40.

Matrix/aggregate ratio in weight: 7:3 with a 20% deviation.

Catalyst: preferably, sodium or potassium hydroxides in scales (commercial use).

Catalyst/dry mixture ratio, in weight: between 3% and 15%, depending on the crystallinity increase intended for the composite. The application of the catalyst must be made after it has been completely diluted in the reaction water. Water/dry mixture ratio, in weight: between 20% and 30%—preferably 25% (it was noted that values below this range cannot completely humidify the mixture and consequently the reaction is incomplete, while for water quantities above this range, the indices of composite crystallinity tend to drop).

Mixing and homogenization: to the aggregate (powdered rubber) only the catalyst, previously diluted in water, is added, slowly and in an adequate device for homogenization (stirrers with low rotation blades, for example), so the entire volume of the rubber is completely humidified. Only then is the aluminosilicate (matrix) added (already mixed with the coloring agents, if this is the case), thus proceeding until the resulting paste is completely hydrated and without lumps, while also featuring a certain plasticity. Molding/casting: The paste resulting from the homogenization process can be used in extrusion mechanisms or proceed to casting by compression. Drying: This is done, preferably, in an oven at 80 degrees Celsius for a minimum period of two hours. This time can be increased to up to six hours for pieces of higher density. Polymerization: This stage comprises the processes of temperature elevation after oven drying, from 80 degrees Celsius to 180 degrees Celsius, remaining at this level for a period of around two hours.

Cure: The removal of the composite from the furnace will be conducted so that cooling is gradual. The composite will feature excellent mechanical characteristics which will be potentialized in up to 30% through dry curing for up to 20 days. Water absorption of the final product: From 15% to 20%,

Thermal/acoustic insulation: Better levels of thermal/acoustic insulation than plastics or timber but lower than those of the ceramic composite, as there occurs a slow degradation of the composite after 220 degrees Celsius. Specific weight: Around 1,200 kg per cubic meter.

Uses: Due to the inherent characteristics of the composite, its applicability is restricted to the cases in which there is no need for high levels of resistance to applying efforts and to water contact.

Surface reinforcement: Optionally, in some specific cases, and aiming to substantially increase the finished product's flexural and/or torsion strength, a mesh of synthetic or natural fibers like polypropylene, cotton, paper, card, polyester, sisal, nylon etc can be glued on the body of the composite in differing quantities and layouts.

Appearance of the finished product: according to the use and need to provide a better finishing of the cast/extruded object's surface, the following may be applied to the latter: PVA-based resins, acrylic or polyurethane resins.

### EXAMPLE 5

### Rubber and Lime Composite

This composite features a high tolerance to water, low specific weight, higher tensile strength than concrete and, furthermore, incorporates some qualities that are inherent to timber and its byproducts, such as tensile strength and the facility with which the composite body is easily sawn, pierced with nails, screwed into etc.

Polymeric matrix: Dry, finely crushed aluminosilicate, passing through sieve #50.

Aggregates: rubber from used car tires (finely crushed and passing through sieves #20 to #40 and hydrated lime.

Matrix/aggregate ratio in weight: 1:1 with a 15% deviation.

Ratio between aggregates in weight: 2:1 (rubber/hydrated lime) with a 30% deviation.

Catalyst: preferably, scaled sodium or potassium hydroxide (commercial use).

Catalyst/dry mixture ratio in weight: between 3% and 15%, depending on the crystallinity increase intended for the composite. The application of the catalyst must be made by completely diluting it in the reaction water.

Water/dry mixture ratio in weight: between 20% and 30%—preferably 25% (it was noted that values below this range cannot completely humidify the mixture and consequently the reaction is incomplete, while for water quantities above this range, the indices of composite crystallinity tend to drop).

Mixing and homogenization: to the aggregate (powdered rubber) only the catalyst, previously diluted in water, is added, slowly and in an adequate device for homogenization (stirrers with low rotation blades, for example), so the entire volume of the rubber is completely humidified. Only then are the lime, and next, the the aluminosilicate (matrix) added (already mixed with the coloring agents, if this is the case), thus proceeding until the resulting paste is completely hydrated and without lumps, while also featuring a certain plasticity.

Molding/casting: The paste resulting from the homogenization process can be used in extrusion mechanisms or proceed to casting by compression. It can also be submitted to molding mechanisms.

Drying: This is done, preferably, in an oven at 80 degrees Celsius for a minimum period of two hours. This time can be increased to up to six hours for pieces of higher density.

Polymerization: This stage comprises the processes of temperature elevation after oven drying, from 80 degrees Celsius to 180 degrees Celsius, remaining at this level for a period of around two hours.

Cure: The removal of the composite from the furnace will be conducted so that cooling is gradual. The composite will feature excellent mechanical characteristics which will be potentialized in up to 50% through dry curing for up to 20 days. Water absorption of the final product: From 15% to 20%,

Thermal/acoustic insulation: Better levels of thermal/acoustic insulation than plastics or timber but lower than those of the ceramic composite, as there occurs a slow degradation of the composite after 220 degrees Celsius. Specific weight: Around 1,350 kg per cubic meter. Uses: Due to the inherent characteristics of the ceramic composite with the incorporation of thermoplastics, it displays great versatility in replacement of timber and by-products, fiber cements, concrete precasts, plastics, gypsum, gypsum wallboards and in some cases even metallic plates and frames. Surface reinforcement: Optionally, in some specific cases, and aiming to substantially increase the finished product's flexural and/or torsion strength, a mesh of synthetic or natural fibers like polypropylene, cotton, paper, card,

polyester, sisal, nylon etc can be glued on the body of the composite in differing quantities and layouts.

Appearance of the finished product: according to the use and need to provide a better finishing of the cast/extruded object's surface, the following may be applied to the latter: polyester epoxy-based, or hybrid polyester-epoxy based, powdered paints, as well as PVA-based resins, acrylic or polyurethane resins and even recycled PET film.

### EXAMPLE 6

### Rubber Composite with Lime and Fibers

Of the composites mentioned so far, manufactured through the processes and with the mixtures described above, this one featuring rubber with lime and fibers has the greatest versatility, both in replacing timbers and their by-products and, thanks to its mechanical characteristics, plastics and resined products, fiber cements, concrete precasts and even some types of metals, offering great flexibility in its application. Polymeric matrix: Dry, finely crushed aluminosilicate, passing through sieve #50. Aggregates: rubber from used car tires (finely crushed and passing through sieves #20 to #40, hydrated lime and alkaline-resistant fibers (polypropylene, PVA, Nylon, etc). Matrix/aggregate ratio in weight: 1:1 with a 15% deviation. Ratio between aggregates in weight: 2:1 with a 30% deviation (rubber/hydrated lime) and up to 8% in polypropylene fibers.

Catalyst: preferably, scaled sodium or potassium hydroxide (commercial use).

Catalyst/dry mixture ratio in weight: between 3% and 15%, depending on the crystallinity increase intended for the composite. The application of the catalyst must be made by completely diluting it in the reaction water.

Water/dry mixture ratio in weight: between 20% and 30%—preferably 25% (it was noted that values below this range cannot completely humidify the mixture and consequently the reaction is incomplete, while for water quantities above this range, the indices of composite crystallinity tend to drop). Mixing and homogenization: to the aggregate (powdered rubber) only the catalyst, previously diluted in water, is added, slowly and in an adequate device for homogenization (stirrers with low rotation blades, for example), so the entire

volume of the rubber is completely humidified. Only then are the lime, and next, the the aluminosilicate (matrix) added (already mixed with the coloring agents, if this is the case), thus proceeding until the resulting paste is completely hydrated and without lumps, while also featuring a certain plasticity. Molding/casting: The paste resulting from the homogenization process can be used in extrusion mechanisms or proceed to casting by compression. It can also be submitted to molding mechanisms.

Drying: This is done, preferably, in an oven at 80 degrees Celsius for a minimum period of two hours. This time can be increased to up to six hours for pieces of higher density.

Polymerization: This stage comprises the processes of temperature elevation after oven drying, from 80 degrees Celsius to 100 degrees Celsius, remaining at this level for a period of around two hours.

Cure: The removal of the composite from the furnace will be conducted so that cooling is gradual. The composite will feature excellent mechanical characteristics which will be potentialized in up to 50% through dry curing for up to 20 days. Water absorption of the final product: From 6% to 10%.

Thermal/acoustic insulation: Better levels of thermal/acoustic insulation than plastics or timber but lower than those of the ceramic composite, as the fiber starts to melt upwards of 130 degrees Celsius and at 220 degrees Celsius the slow degradation of the rubber begins to occur.

Specific weight: Around 1,350 kg per cubic meter.

Uses: Due to the inherent characteristics of the ceramic composite with the incorporation of thermoplastics, it displays great versatility in replacement of timber and by-products, fiber cements, concrete precasts, plastics, gypsum, gypsum wallboards and in some cases even metallic plates and frames.

Surface reinforcement: Optionally, in some specific cases, and aiming to substantially increase the finished product's flexural and/or torsion strength, a mesh of synthetic or natural fibers like polypropylene, cotton, paper, card, polyester, sisal, nylon etc can be glued on the body of the composite in differing quantities and layouts.

Appearance of the finished product: according to the use and need to provide a better finishing of the cast/extruded object's surface, the following may be applied to the latter: polyester epoxy-based, or hybrid polyester-epoxy based, powdered paints, as well as PVA-based resins, acrylic or polyurethane resins and even recycled PET film.

### EXAMPLE 7

### Vermiculite Composite

Such composites are characterized by the close relation between the amount of water used in the reaction and the specific strength/weight achieved. Polymeric matrix: Dry, finely crushed aluminosilicate, passing through sieve #50.

Aggregates: lose and dry expanded vermiculite.

Matrix/aggregate ratio in weight: 60% to 85% matrix (aluminosilicate) and from 15% to 40% in vermiculite.

Catalyst: preferably, scaled sodium or potassium hydroxide (commercial use).

Catalyst/dry mixture ratio in weight: between 3% and 15%, depending on the crystallinity increase intended for the composite. The application of the catalyst must be made by completely diluting it in the reaction water.

Water/dry mixture ratio in weight: between 30% and 75% (it was noted that values in this range promote the reaction but produce results for specific strength and weight which are inversely proportional to the amount of water used, and must thus be adjusted according to the use intended for the product).

Mixing and homogenization: to the dry mixture the catalyst, previously diluted in water (already mixed with the coloring agents, if this is the case), is added, slowly and in an adequate device for homogenization (stirrers with low rotation blades, for example), thus proceeding until the resulting paste is completely hydrated and without lumps, while also featuring a certain plasticity.

Molding/casting: The paste resulting from the homogenization process can be used in extrusion mechanisms or proceed to casting by compression.

Drying: This is done, preferably, in an oven at 80 degrees Celsius for a minimum period of two hours. This time can be increased to up to six hours for pieces of higher density.

Polymerization: This stage comprises the processes of temperature elevation after oven drying in a furnace at up to 500 degrees Celsius, remaining at this level for a period of around one hour.

Cure: The removal of the composite from the furnace will be conducted so that cooling is gradual. Early strength is regular only, but it grows considerably by the twentieth day after polymerization.

Water absorption of the final product: This characteristic is intrinsic to the amount of reaction water, varying as in the following examples:
34% of water/dry mixture—absorption of 30% (features good levels of flexural and abrasion strengths).
54% of water/dry mixture—absorption of 50% (features good levels of flexural and abrasion strengths).
75% of water/dry mixture—absorption of 63% (features poor levels of flexural and abrasion strengths) Thermal/acoustic insulation: Excellent, much superior to that of traditional ceramics.

Specific weight: From 650 kg to 1300 kg per cubic meter.

Uses: Due to the inherent characteristics of the composite with vermiculite, it will substitute products that usually require low specific weight and excellent thermal-acoustic insulation, such as air conditioner ducts, plates, bricks, gutters, light precasts and insulating and sealing renderings.

Surface reinforcement: Optionally, in some specific cases, and aiming to substantially increase the finished product's flexural and/or torsion strength, a mesh of synthetic or natural fibers like polypropylene, cotton, paper, card, polyester, sisal, nylon etc can be glued on the body of the composite in differing quantities and layouts.

Appearance of the finished product: according to the use and need to provide a better finishing of the cast/extruded object's surface, the following may be applied to the latter: polyester epoxy-based, or hybrid polyester-epoxy based, powdered paints, as well as PVA-based resins, acrylic or polyurethane resins and even recycled PET film.

### EXAMPLE 8

### Vermiculite, Limestone and Lime Composite

This composite features a substantial improvement in mechanical characteristics, with the use of other aggregates besides vermiculite, such as sand, limestone powder and/or hydrated lime. Polymeric matrix: Dry, finely crushed aluminosilicate, passing through sieve #50.

Aggregates: dry, loose, expanded vermiculite, hydrated lime and sand and/or limestone powder.

Matrix/aggregates ratio in weight: 60% to 85% matrix (aluminosilicate) and from 15% to 35% of vermiculite, 10% to 25% of hydrated lime and 0% to 15% of sand and/or limestone powder.

Catalyst: preferably, scaled sodium or potassium hydroxide (commercial use).

Water/dry mixture ratio in weight: between 3% and 15%, depending on the crystallinity increase intended for the composite. The application of the catalyst must be made by completely diluting it in the reaction water. Water/dry mixture ratio in weight: between 30% and 75% (it was noted that values in this range promote the reaction but produce results for specific strength and weight which are inversely proportional to the amount of water used, and must thus be adjusted according to the use intended for the product).

Mixing and homogenization: to the dry mixture the catalyst, previously diluted in water (already mixed with the coloring agents, if this is the case), is added, slowly and in an adequate device for homogenization (stirrers with low rotation blades, for example), thus proceeding until the resulting paste is completely hydrated and without lumps, while also featuring a certain plasticity.

Molding/casting: The paste resulting from the homogenization process can be used in extrusion mechanisms or proceed to casting by compression.

Drying: This is done, preferably, in an oven at 80 degrees Celsius for a minimum period of two hours. This time can be increased to up to six hours for pieces of higher density.

Polymerization: This stage comprises the processes of temperature elevation after oven drying in a furnace at up to 500 degrees Celsius, remaining at this level for a period of around one hour.

Cure: The removal of the composite from the furnace will be conducted so that cooling is gradual. Early strength is regular only, but it grows considerably by the twentieth day after polymerization.

Water absorption of the final product: This characteristic is intrinsic to the amount of reaction water, varying as in the following examples:
34% of water/dry mixture—absorption of 30% (features good levels of flexural and abrasion strengths).
54% of water/dry mixture—absorption of 50% (features good levels of flexural and abrasion strengths).—75% of water/dry mixture—absorption of 63% (features poor levels of flexural and abrasion strengths)

Thermal/acoustic insulation: Excellent, much superior to that of traditional ceramics. Specific weight: From 650 kg to 1300 kg per cubic meter. Uses: Due to the inherent characteristics of the composite with vermiculite, it will substitute products that usually require low specific weight and excellent thermal-acoustic insulation, such as air conditioner ducts, plates, bricks, gutters, light precasts and insulating and sealing renderings. Surface reinforcement: Optionally, in some specific cases, and aiming to substantially increase the finished product's flexural and/or torsion strength, a mesh of synthetic or natural fibers like polypropylene, cotton, paper, card, polyester, sisal, nylon etc can be glued on the body of the composite in differing quantities and layouts. Appearance of the finished product: according to the use and need to provide a better finishing of the cast/extruded object's surface, the following may be applied to the latter: polyester epoxy-based, or hybrid polyester-epoxy based, powdered paints, as well as PVA-based resins, acrylic or polyurethane resins and even recycled PET film.

### EXAMPLE 9

### Ceramic Composite with Lime and Asbestos Fibers

This composite incorporates some of the characteristics of timber and its by-products such as tensile strength and the facility with which the composite body is easily sawn, pierced with nails, screwed into etc.

Polymeric matrix: Dry, finely crushed aluminosilicate, passing through sieve #50.

Aggregates: Dry, washed sand, limestone powder and hydrated lime, and asbestos fibers.

Matrix/aggregates ratio in weight: 1:1 with 15% deviation.

Ratio between aggregates in weight: 1:1 (sand and/or limestone powder)/hydrated lime with 35% deviation, added by dry mixture of asbestos fibers in up to 15% of total weight. Catalyst: preferably, scaled sodium or potassium hydroxide (commercial use).

Catalyst/dry mixture ratio in weight: between 3% and 12%, depending on the crystallinity increase intended for the composite. The application of the catalyst must be made by completely diluting it in the reaction water.

Water/dry mixture ratio in weight: between 20% and 30%—preferably 25% (it was noted that values below this range cannot completely humidify the mixture and consequently the reaction is incomplete, while for water quantities above this range, the indices of composite crystallinity tend to drop).

Mixing and homogenization: to the dry mixture the catalyst, previously diluted in water (already mixed with the coloring agents, if this is the case), is added, slowly and in an adequate device for homogenization (stirrers with low rotation blades, for example), thus proceeding until the resulting paste is completely hydrated and without lumps, while also featuring a certain plasticity.

Molding/casting: The paste resulting from the homogenization process can be used in extrusion mechanisms or proceed to casting by compression. It can also be submitted to molding mechanisms.

Drying: This is done, preferably, in an oven at 80 degrees Celsius for a minimum period of two hours. This time can be increased to up to six hours for pieces of higher density.

Polymerization: This stage comprises the processes of temperature elevation after oven drying, from 80 degrees Celsius to 500 degrees Celsius, remaining at this level for a period of around two hours.

Cure: The removal of the composite from the oven will be conducted so that cooling is gradual. The composite will feature excellent mechanical characteristics which will be potentialized in up to 50% through dry curing for up to 20 days.

Water absorption of the final product: From 13% to 16%, comparable to traditional red ceramics.

Thermal/acoustic insulation: Excellent, comparable to that of traditional ceramics and superior to fiber cement.

Specific weight: Around 1,850 kg per cubic meter.

Uses: Due to the inherent characteristics of the ceramic composite with lime and fibers, it displays great versatility in replacement of timber and by-products, fiber cements, concrete precasts, plastics, gypsum, gypsum wallboards and in some cases even metallic plates and frames.

Surface reinforcement: Optionally, in some specific cases, and aiming to substantially increase the finished product's flexural and/or torsion strength, a mesh of synthetic or natural fibers like polypropylene, cotton, paper, card, polyester, sisal, nylon etc can be glued on the body of the composite in differing quantities and layouts.

Appearance of the finished product: according to the use and need to provide a better finishing of the cast/extruded object's surface, the following may be applied to the latter: polyester epoxy-based, or hybrid polyester-epoxy based, powdered paints, as well as PVA-based resins, acrylic or polyurethane resins and even recycled PET film.

To be sure, in the employment of the processes described above, other composite variables (both natural and synthetic ones) may play a part, given the possibility offered by the aluminosilicate (clay) to mix with aggregates of various types and which have not been included here. However, to produce any composite, the stages and mixtures described in the present report need to be observed as well as the addition of an aqueous solution-based catalyst, comprising preferably sodium (70%) or potassium hydroxides in scales (commercial use), and the need to submit the artifacts to the drying and polymerization processes within the temperature scales indicated above.

1) “NATURAL ALUMINOSILICATE COMPOSITES AND AGGREGATES SYNTHESIZED IN ALKALINE ENVIRONMENT AND THEIR MANUFACTURING PROCESS” which, unlike the technique in current processes, is characterized by comprising a direct reactive process which does not require any type of chemical or thermal pre-activation of the components of the inorganic polymerization reaction, and also relieves the process of the strict observance of the molar fractions related to the reactors, enabling the use of industrial methods of compression, extrusion, drying and burning in continuous production, to obtain composites, through the mixture of clay (natural aluminosilicate) which must feature the mineralogical characterization of kaolinite in absolute predominance in X-Ray diffraction analysis, preferably low crystallinity (BET method), relatively high loss to ignition (apparently related to the high content of hydroxides) in the region of 8% and 15%, and with Al2O3 content between 28% and 40% and SiO2 content between 40% and 60% in the analysis by X-ray fluorescence spectrometry, displaying also a minimal content of amorphous material of 0.5% and virtually null content of alkaline oxides (K2O and Na2O), with one or more natural aggregates, understood by silica, limestone, granite or marble powder, hydrated lime, vermiculite, asbestos fibers, and/or with the addition of synthetic aggregates, understood by tire rubber, polypropylene, nylon fibers, PVA fibers, which will be mixed until a complete homogenization is achieved with the addition of an aqueous alkaline solution using sodium hydroxides and/or potassium hydroxide or substitutes based on sodium silicate, sodium metasilicate or sodium carbonate, so as to obtain a homogeneous paste capable of undergoing extrusion and/or casting and will allow the cutting of pieces (artifacts) which will be taken to a drying oven at an average temperature of 80° C. for a period of at least two hours for later polymerization, which will take place in a heated furnace for at least an hour at temperatures ranging from 100° C. and 500° C.

2) “NATURAL ALUMINOSILICATE COMPOSITES AND AGGREGATES SYNTHESIZED IN ALKALINE ENVIRONMENT AND THEIR MANUFACTURING PROCESS” to be used in the manufacture of artifacts of several types, such as: tiles, bricks, blocks, coatings, precasts and any other artifact that can be cast or extruded, thus being a Ceramic composite characterized by a dry Specific aluminosilicate as polymeric matrix, mixed with natural aggregates, understood by dry washed sand and/or limestone, granite or marble powder, with a matrix/aggregates ratio in weight of one to one “1:1”, with maximum deviation of 15% and with a ration between aggregates in weight (sand and/or limestone granite or marble powder) of one to one “1:1” with 50% deviation, added by an alkaline catalyst in aqueous solution (H2O+NAHO and/or KOH) and whose catalyst/dry mixture ratio in weight will be between 1.5% and 12%, with best reactive efficiency at 7%, and a water/dry mixture ratio in weight between 10% and 20% with best effectiveness at 14%; all of these homogeneously mixed for subsequent molding and casting of the artifacts and drying in an oven at 80° C. for two hours and furnace polymerization in up to 500° C. for a period of around an hour.

3) “NATURAL ALUMINOSILICATE COMPOSITES AND AGGREGATES SYNTHESIZED IN ALKALINE ENVIRONMENT AND THEIR MANUFACTURING PROCESS” is also characterized, according to claim #2, by the addition of hydrated lime in the mixture with the natural aggregates with a ratio in weight between aggregates of two to one “2:1” (sand and/or limestone powder)/hydrated lime with a deviation of around 35%.

4) “NATURAL ALUMINOSILICATE COMPOSITES AND AGGREGATES SYNTHESIZED) IN ALKALINE ENVIRONMENT AND THEIR MANUFACTURING PROCESS” is, according to claims #2 and #3, characterized by comprising the addition of alkaline-resistant synthetic fibers (polypropylene, nylon, PVA, etc.) in the proportion of up to 8% (best efficiency at 3%) over the total weight of the dry mixture, with the addition, however, of an alkaline catalyst in aqueous solution (H2O and NAOH and/or KOH) and the catalyst/dry mixture ratio in weight between 3% and 12% (best reactive efficiency at 7%) and water/dry mixture ratio in weight between 20% and 30%, with best results at 25%, and further comprising polymerization in the oven itself by raising the temperature from 80° C. to 100° C. for a period of around two hours.

5) “NATURAL ALUMINOSILICATE COMPOSITES AND AGGREGATES SYNTHESIZED IN ALKALINE ENVIRONMENT AND THEIR MANUFACTURING PROCESS” to be used in the manufacture of artifacts to replace gypsum in precast pieces and other artifacts in which there is no requirement for good levels of resistance to applying efforts nor to contact with water, thus constituting the Rubber composite characterized by a dry Specific aluminosilicate as a polymeric matrix, mixed with the tire rubber aggregate with a matrix/aggregates ratio in weight of seven thirds “7:3” with deviation around 20%, added to an alkaline catalyst in aqueous solution (H2O and NAOH and/or KOH) and the catalyst/dry mixture ratio in weight between 3% and 15% (best reactive efficiency at 7%) and water/dry mixture ratio in weight between 20% and 30%, with best results at 25%, all of these homogeneously mixed for subsequent molding and casting of the artifacts and drying in an oven at temperatures starting at 80° C. and raised to 180° C. for a period of around two hours.

6) “NATURAL ALUMINOSILICATE COMPOSITES AND AGGREGATES SYNTHESIZED IN ALKALINE ENVIRONMENT AND THEIR MANUFACTURING PROCESS” is also characterized, according to claim #5, by the addition of hydrated lime as an aggregate, maintaining a ratio in weight between the aggregates (tire rubber/hydrated lime) at two to one “2:1”, with a deviation around 30% and a total matrix/aggregates ratio in weight of one to one “1:1”, with a deviation of around 15%.

7) “NATURAL ALUMINOSILICATE COMPOSITES AND AGGREGATES SYNTHESIZED IN ALKALINE ENVIRONMENT AND THEIR MANUFACTURING PROCESS” is also characterized, according to claims #5 and #6, by comprising the addition of alkaline-resistant synthetic fibers (polypropylene, nylon, PVA, etc.) in the proportion of up to 8% (best efficiency at 3%) over the total weight of the dry mixture, with a matrix/aggregates ratio in weight of one to one “1:1” with a deviation around 15% and further comprising polymerization in the oven itself by raising the temperature from 80° C. to 100° C. for a period of around two hours.

8) “NATURAL ALUMINOSILICATE COMPOSITES AND AGGREGATES SYNTHESIZED IN ALKALINE ENVIRONMENT AND THEIR MANUFACTURING PROCESS” to be used in the manufacture of air conditioning ducts, plates, gutters, light precasts and insulating and sealing renderings, thus comprising the Vermiculite Composite, which is characterized by a dry Specific aluminosilicate as a polymeric matrix, mixed with the expanded, dry and loose vermiculite aggregate, considering the following proportions in total weight for the dry mixture as between 60% and 85% for the said polymeric matrix (aluminosilicate) and from 15% to 40% of vermiculite, added by the alkaline catalyst in aqueous solution (H2O and NAHO and/or KOH) whose catalyst/dry mixture ratio in weight will be between 3% and 15% with best reactive efficiency at 7%, and furthermore, featuring the water/dry mixture ratio in weight between 30% and 75%, all of which are homogeneously mixed for subsequent molding and casting of the artifacts and drying in an oven at 80° C. for two hours and furnace polymerization in up to 500° C. for a period of around an hour.

9) “NATURAL ALUMINOSILICATE COMPOSITES AND AGGREGATES SYNTHESIZED IN ALKALINE ENVIRONMENT AND THEIR MANUFACTURING PROCESS” is also characterized, according to claim #8, by comprising the addition of limestone powder and/or sand and/or hydrated lime, maintaining a proportion in weight from 60% to 85% for the polymeric matrix (aluminosilicate) and from 15% to 35% of vermiculite, 10% to 25% of hydrated lime and of up to 15% of limestone powder and/or sand.

10) “NATURAL ALUMINOSILICATE COMPOSITES AND AGGREGATES SYNTHESIZED IN ALKALINE ENVIRONMENT AND THEIR MANUFACTURING PROCESS” is also characterized, according to claims #8 and #9, by obtaining composites through the addition of alkalinity-resistant synthetic fibers (polypropylene, nylon, PVA, etc.) in the proportion of up to 8% (best efficiency at 3%) over the total weight of the dry mixture, maintaining a weight proportion of 60% to 85% for the polymeric matrix (aluminosilicate) and from 15% to 35% of vermiculite, 10% to 25% of hydrated lime and of up to 15% of limestone powder and/or sand, further comprising polymerization in the oven itself by raising the temperature from 80° C. to 100° C. for a period of around two hours.

11) “NATURAL ALUMINOSILICATE COMPOSITES AND AGGREGATES SYNTHESIZED IN ALKALINE ENVIRONMENT AND THEIR MANUFACTURING PROCESS” according to claims #2 to #10, the composites obtained are also characterized by comprising an increase in flexural and/or torsion strength of the finished product by including meshes of synthetic or natural fibers, such as polypropylene, cotton, paper, card, polyester, sisal, nylon etc, which are glued to the body of the composite in varying quantities and layouts and also for comprising the use of superior finishing of the surface of the cast or extruded object through the use of polyester epoxy-based, or hybrid polyester-epoxy based, powdered paints, as well as PVA-based resins, acrylic or polyurethane resins and even recycled PET film.

12) “NATURAL ALUMINOSILICATE COMPOSITES AND AGGREGATES SYNTHESIZED IN ALKALINE ENVIRONMENT AND THEIR MANUFACTURING PROCESS” according to claims #2 to #10, the composites obtained are also characterized by the optional use of various coloring agents added to the composite paste with a view to adjusting the product to specific aesthetic characteristics.

13) “NATURAL ALUMINOSILICATE COMPOSITES AND AGGREGATES SYNTHESIZED IN ALKALINE ENVIRONMENT AND THEIR MANUFACTURING PROCESS” according to claims #2 and #3 is also characterized by the addition of asbestos fibers in the proportion of up to 15% (best efficiency at 9%) over the total weight of the dry mixture, with the addition, however, of the alkaline catalyst in aqueous solution (H2O and NAOH and/or KOH) at the catalyst/dry mixture ratio in weight between 3% and 12% and the water/dry mixture ratio in weight between 20% and 30%, with best results at 25%, also comprising the polymerization in furnace with temperature elevation from 80° C. to 500° C. for a period of around two hours.

14) “NATURAL ALUMINOSILICATE COMPOSITES AND AGGREGATES SYNTHESIZED IN ALKALINE ENVIRONMENT AND THEIR MANUFACTURING PROCESS” according to claims #5 and #6, is also characterized by comprising the addition of asbestos fibers at the proportion of up to 15% (best efficiency at 9%) over the total weight of the dry mixture, with a matrix/aggregates ratio in weight of one to one “1:1” with a deviation of 15% and polymerization in the oven itself with a temperature elevation from 80° C. to 200° C. for a period of around two hours.

15) “NATURAL ALUMINOSILICATE COMPOSITES AND AGGREGATES SYNTHESIZED IN ALKALINE ENVIRONMENT AND THEIR MANUFACTURING PROCESS” according to claims #8 and #9, the composites obtained are also characterized by comprising the addition of asbestos fibers in the proportion of up to 15% (best efficiency at 9%) over the total weight of the dry mixture, maintaining a weight proportion from 60% to 85% for the polymeric matrix (aluminosilicate) and from 15% to 35% of vermiculite, 10% to 25% of hydrated lime and of up to 15% of limestone powder and/or sand, and the polymerization in a furnace with a temperature elevation from 80° C. to up to 500° C. for a period of around two hours.
